(19) United States
(12) Patent Application Publication
(10) Pub. No.: US 2014/0056327 A1
(43) Pub. Date: Feb. 27, 2014

(54) STATUS INDICATOR FOR TEMPERATURE-SENSITIVE GOODS

(71) Applicants: Michael Maier, Lauchheim/Hülen (DE); Martin Rabinen, Ellwangen (DE)

(72) Inventors: Michael Maier, Lauchheim/Hülen (DE); Martin Rabinen, Ellwangen (DE)

(73) Assignee: Varta Microbattery GmbH, Ellwangen (DE)

(21) Appl. No.: 14/001,303

(22) PCT Filed: Feb. 10, 2012
(86) PCT No.: PCT/EP12/52252

§ 371 Date: Nov. 6, 2013

(30) Foreign Application Priority Data
Feb. 25, 2011 (DE) 10 2011 004 799.9

(51) Int. Cl. G01K 3/04

(52) U.S. Cl. CPC G01K 3/04
USPC 374/102

(57) ABSTRACT

An apparatus that monitors temperature of temperature-sensitive goods includes a gas generation cell, an NTC thermistor, and an indicator device, wherein the gas generation cell, the NTC thermistor and the indication means are coupled to one another such that, when current flows through the NTC thermistor, a quantity of gas equivalent to a quantity of current flowing through the NTC thermistor is generated by the gas generation cell, and the indicator device changes its state and/or its position depending on the generated quantity of gas.

### TECHNICAL FIELD

This disclosure relates to a method of monitoring the temperature of temperature-sensitive goods, and to an apparatus suitable for this purpose.

### BACKGROUND

To preserve temperature-sensitive goods, for example, perishable food products over a relatively long period of time or to transport the goods over relatively long distances, the goods are usually refrigerated or deep-frozen. The natural decomposition of food products comes virtually completely to a stop at below −16° C. to −18° C. Frozen goods may possibly be stored over several months at these temperatures. However, the refrigeration chain should never be interrupted in the event of relatively long-term storage or relatively long-term transportation. Microorganisms which promote decomposition are not killed off in the event of refrigeration or freezing. The metabolism of the microorganisms is immediately reactivated upon thawing. As far as possible, food products which have been frozen and then thawed should not be deep-frozen and thawed for a second time, but rather consumed immediately.

There is great interest, in particular on the part of consumers and on the part of individual traders, to be able to identify quickly and reliably whether refrigerated or deep-frozen food products have been correctly stored or whether the refrigeration chain has been interrupted, for example, during transportation.

DE 27 36 470 A1 discloses an apparatus that establishes over the long term whether a product which has been deep-frozen has been temporarily reheated. The described apparatus has a capsule arranged on the packaging of the food product and is filled with a liquid. The capsule is composed of breakable material. If the product is deep-frozen, the liquid which solidifies in the capsule expands, wherein the capsule bursts on account of the increase in volume. As long as the temperature does not increase, the frozen liquid does not drain off. This only happens upon thawing. In this case, the liquid which drains off may be absorbed by a substance which surrounds the capsule and permanently changes the color of the substance. Therefore, it is possible to identify whether the refrigeration chain has been interrupted or whether the product is fresh or was previously frozen.

DE 38 01 541 A1 describes an indicator to monitor the temperature of refrigerated products. The indicator is battery-operated and arranged on a thermally insulating packaging. The indicator is able to electronically detect the temperature in the interior of the packaging. The current temperature, the maximum temperature reached and possibly the total period for which a lower limit temperature was exceeded are displayed on an LCD display.

It could therefore be helpful to provide a procedure comparable to the described method, but can be used universally and at the same time is as cost-effective as possible.

### SUMMARY

We provide an apparatus that monitors temperature of temperature-sensitive goods including a gas generation cell, an NTC thermistor, and an indicator device, wherein the gas generation cell, the NTC thermistor and the indicator device are coupled to one another such that, when current flows through the NTC thermistor, a quantity of gas equivalent to a quantity of current flowing through the NTC thermistor is generated by the gas generations cell, and the indicator device changes its state and/or its position depending on the generated quantity of gas.

We also provide a method of monitoring temperature in a transportation container for temperature-sensitive goods including detecting the temperature within the transportation vessel by an NTC thermistor coupled to a gas generation cell that generates a quantity of gas depending on a quantity of current flowing through the NTC thermistor, and wherein the gas generation cell is coupled to an indicator device which changes its state and/or its position depending on the generated quantity of gas.

### BRIEF DESCRIPTION OF THE DRAWING

FIG. 1 shows a schematic section through a preferred example of our apparatus.

### DETAILED DESCRIPTION

Our apparatus comprises a gas generation cell, an NTC thermistor and an indication means.

The apparatus is used to monitor the temperature of temperature-sensitive goods, in particular goods located in a corresponding transportation vessel. The apparatus can be used, in principle, to monitor the temperatures of all articles which could be damaged if defined temperatures are exceeded. These include, for example, pharmaceutical and biotechnology products, medical samples such as, for example, tissue or blood samples, and also sensitive electronic components. However, the goods to be transported are particularly preferably food products, in particular refrigerated or deep-frozen food products.

A limit temperature above which the products may be damaged can generally be specified for the products which are to be monitored. It is necessary to record fluctuations in temperature of this kind by our apparatus.

Suitable transportation vessels for goods of this kind are usually thermally insulated. The apparatus is suitable for monitoring the temperature in transportation vessels of any type and size, for example, in transportation boxes or in transportation containers.

A gas generation cell is a cell which releases a gas when current flows through it. In this case, the quantity of released gas is generally proportional to the quantity of the current which flows through the gas generation cell, in line with Faraday's Law. One example of a gas evolution cell which can be used is a hydrogen evolution cell. A hydrogen evolution cell generally has a metal-containing, in particular a zinc-containing, material as the oxidizable anode, a hydrogen cathode and an aqueous, preferably alkaline, electrolyte. In a hydrogen evolution cell of this kind, hydrogen is stored chemically in the form of water as a main constituent part of the electrolyte. Cells of this kind are described, for example, in DE 36 43 352 A1 and in U.S. Pat. No. 5,242,565, the subject matter of which is hereby incorporated by reference.

An NTC (negative temperature coefficient) thermistor is a special electrical resistor which conducts current better at high temperatures than at low temperatures. NTC thermistors therefore have a negative temperature coefficient from which their name is derived. As an alternative, they are also called “high-temperature conductors.” By way of example, pure semiconductor materials, connecting semiconductors and various alloys with a negative temperature coefficient exhibit thermally conductive behavior. Electronic components in which the temperature-dependent conductive behavior is specially utilized are usually pressed and sintered metal oxides with admixed binder. The metal oxides include oxides of manganese, nickel, cobalt, iron, copper or titanium. The usual area of use of NTC thermistors is minus 80° C. to plus 250° C. The apparatus is accordingly, in particular, also used to monitor temperatures in this range.

The indication means/indicator device is used to display fluctuations in temperature which may occur during monitoring, at least in respect of the limit temperature having been exceeded.

The gas generation cell, the NTC thermistor and the indication means are coupled to one another such that, when current flows through the NTC thermistor, a quantity of gas equivalent to the quantity of current flowing through the NTC thermistor is generated by the gas generation cell, and the indication means changes its state and/or its position depending on the generated quantity of gas to display this.

The NTC thermistor is ideally selected such that it has an appreciable electrical conductivity only above the limit temperature.

The NTC thermistor and the gas generation cell are preferably constituent parts of a closed circuit or form a closed circuit. The NTC thermistor and the gas generation cell are preferably connected electrically in series within the circuit. In the simplest case, the circuit therefore comprises a gas generation cell, the poles of the gas generation cell being short-circuited by the NTC thermistor.

If, for example, an NTC thermistor which is electrically conductive only above minus 20° C. is used, current flow between the poles of the gas generation cell across the NTC thermistor will be tripped each time the limit temperature is exceeded, as a result of which a defined quantity of gas will be released. Afterward, conclusions can be drawn from the quantity of gas formed about the time for which and/or the amount by which the limit temperature was exceeded.

As already mentioned, the state and/or the position of an indication means is changed by the generated gas. To this end, it is preferred for the gas generation cell and the indication means to be coupled to one another in a gas-tight manner by a connection means/connector. A suitable connection means is, for example, a tubular adapter. However, it is also feasible for the connection means to be in the form of a housing or in the form of part of a housing which surrounds the gas generation cell and the indication means, possibly also the NTC thermistor, in a gas-tight manner.

Therefore, the indication means can be, for example, a displacement element mounted such that it can move in a housing which surrounds the displacement element. The displacement element preferably forms a closed hollow space with the housing, it being possible for the volume of the hollow space to be changed. This hollow space can be coupled to the gas generation cell, in particular by one of the connection means. If gas is generated by the gas generation cell, a pressure is formed in the hollow space, the pressure, in turn, resulting in a change in position of the displacement element. The magnitude of this change in position is an indicator of a limit temperature possibly being exceeded and the duration of this. The displacement element is, for example, a piston, in particular a cylindrical piston. Suitable housings for movably mounting displacement elements of this kind are, for example, hollow-cylindrical pipes or tubes.

Alternatively, the indication means may be an expandable component which changes its volume depending on the generated quantity of gas. The generated quantity of gas therefore causes a change in the state of the component. The magnitude of this change in state, the increase in volume, like the change in position of the sliding element, allows conclusions to be drawn about whether and to what extent the temperature which is to be monitored has been exceeded.

The apparatus particularly preferably comprises a scale with the aid of which the change in position and/or state of the indication means can be read off in a simple manner. The scale may be both a numerical scale and also a color scale. For example, it is possible to use as the indication means a piston which is movably mounted in a transparent hollow cylinder and of which the casing is provided with a calibrated scale. This scale can be used to easily read off whether and, if so, to what extent the indication means, the piston, has been displaced in the hollow cylinder.

As already mentioned, we provide a method of monitoring the temperature in a transportation container for temperature-sensitive goods. In this method, the temperature within the transportation vessel is detected by an NTC thermistor. As has already been described, the NTC thermistor is coupled to a gas generation cell which generates a quantity of gas depending on the quantity of current flowing through the NTC thermistor, the quantity of gas changing the state and/or the position of an indication means coupled to the gas generation cell.

In particular, the method can be carried out using our apparatus. Accordingly, all the statements made in relation to preferred features of the apparatus also apply to the corresponding features of our method.

Further features and advantages of the described method can be found in the following description of the apparatus. The described preferred example is used merely for explanation and to better understanding and is not to be understood to be restrictive in any way.

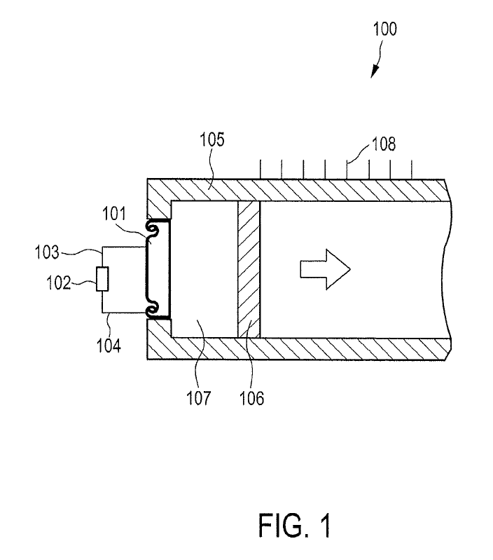

A gas generation cell 101 in the form of a button cell is coupled to the NTC thermistor 102 in FIG. 1. The gas generation cell 101 has an open-circuit voltage. When a defined limit temperature is exceeded, current can flow through the NTC thermistor 102. Since the NTC thermistor 102 and the gas generation cell 101 are electrically connected in series, the same quantity of current flows through both components. The NTC thermistor 102 and the gas generation cell 101 form a closed circuit with the electrical conductors 103 and 104 which connect them. According to Faraday's Law, when current flows through the gas generation cell 101, a quantity of gas which is proportional to the current flowing through the gas generation cell is generated.

The gas generation cell 101 is incorporated in the base of a tubular hollow cylinder 105 in a gas-tight manner. The piston 106, which is used as the indication means, is displaceably mounted in the hollow cylinder 105. The side walls and the base of the hollow cylinder 105 form an adapter-like connection between the gas generation cell 101, which is incorporated in the base, and the piston 106 which functions as the indication means. The piston 106 forms a closed hollow space 107 with the casing and the base of the hollow cylinder, it being possible for the volume of the hollow space to be changed by displacement of the piston 106. The gas which is formed by the gas generation cell 101 is conducted into the hollow space 107. For this purpose, the gas generation cell 101 has suitable outlet openings which issue into the hollow space 107. The piston 106 is displaced in the direction of the arrow by the gas which flows into the hollow space 107 and therefore changes its position depending on the generated quantity of gas.

The numerical scale 108 is arranged on the outside of the casing of the cylindrical pipe 105. The extent of the change in position of the piston 106 can be quantified with the aid of this scale 108. The tubular hollow cylinder 105 is ideally of transparent design for this purpose. The hollow cylinder can be composed, for example, of glass or a plastic.

1. An apparatus that monitors temperature of temperature-sensitive goods comprising:
a gas generation cell;
an NTC thermistor; and
an indicator device,
wherein the gas generation cell, the NTC thermistor and the indication means are coupled to one another such that, when current flows through the NTC thermistor, a quantity of gas equivalent to a quantity of current flowing through the NTC thermistor is generated by the gas generation cell, and the indicator device changes its state and/or its position depending on the generated quantity of gas.

2. The apparatus as claimed in claim 1, wherein the NTC thermistor and the gas generation cell are constituent parts of a closed circuit or form a closed circuit and are electrically connected in series within the circuit.

3. The apparatus as claimed in claim 1, wherein the gas generation cell and the indicator device are coupled to one another in a gas-tight manner by a tubular adapter as a connector.

4. The apparatus as claimed in claim 1, wherein the indicator device is a movably mounted displacement element.

5. The apparatus as claimed in claim 1, wherein the indicator device is an expandable component which changes its volume depending on the generated quantity of gas.

6. The apparatus as claimed in claim 1, further comprising a scale with which the change in position and/or state of the indicator device can be read.

7. A method of monitoring temperature in a transportation container for temperature-sensitive goods comprising detecting the temperature within the transportation vessel by an NTC thermistor coupled to a gas generation cell that generates a quantity of gas depending on a quantity of current flowing through the NTC thermistor, and wherein the gas generation cell is coupled to an indicator device which changes its state and/or its position depending on the generated quantity of gas.
